(19) United States
(12) Patent Application Publication
(10) Pub. No.: US 2007/0034421 A1
(43) Pub. Date: Feb. 15, 2007

(54) Weighing Spoon

(75) Inventors: Waiming Ho, Tsuen Wan (HK); Ming Lee, Sheung Wan (HK)

Correspondence Address: BUCHANAN, INGERSOLL & ROONEY PC, POST OFFICE BOX 1404, ALEXANDRIA, VA, 22313-1404, US

(73) Assignee: Mingle Metal (Shen Zhen) Co. Limited, Shenzhen (CN)

(21) Appl. No.: 11/277,154

(22) Filed: Mar. 22, 2006

(30) Foreign Application Priority Data
Aug. 10, 2005 (CN) 200520103573.3

(51) Int. Cl. G01G 19/56

(52) U.S. Cl. 177/149

(57) ABSTRACT

The present utility model discloses a weighing spoon, comprising a spoon body, a holder body, and a level meter, wherein the spoon body is connected via a spoon stem with a weighing sensor disposed in the holder body, and the level meter is mounted in the holder body having a hanging ring attached thereto. A liquid crystal display is disposed in the holder body. The weighing sensor is connected to the liquid crystal display by means of A/D converter on the circuit board and a circuit of a microprocessor. The holder body is a housing composed of the panel, a button, an upper case, a lower case and a battery cover. In the interior of the holder body are disposed a rubber button and a circuit board and a battery. A seal ring is provided between the battery cover and the lower case to improve water resistance thereof. The weight indicated by the weighing sensor is displayed on the liquid crystal display when needed, and the level meter is used to control the data read from the spoon in the horizontal state most accurate. The spoon according to the present utility model is reasonable in structure, and a user can precisely control the amount of the article needed, and meanwhile the spoon can be conveniently placed by means of a hanging ring provided.

### TECHNICAL FIELD

The present utility model relates to a weighing spoon, and in particular to a spoon for weighing the seasonings used in a kitchen.

### BACKGROUND ART

Spoons in the prior art are mostly of an integrally formed structure that is simple, and such spoons do not have other applications, so they cannot be used to strictly control the amount of the article contained in the spoon so as to meet a user's needs.

### SUMMARY OF THE PRESENT UTILITY MODEL

To overcome the aforesaid drawbacks, the present utility model provides a weighing spoon, comprising a spoon body, a holder body, a level meter and a hanging ring, wherein said spoon body consists of a spoon head and a spoon stem, the spoon stem is connected to a weighing sensor disposed in said holder body, the hanging ring is attached to said holder body so that the spoon can be hung via the hanging ring; said holder body can be further provided with a liquid crystal display, the weighing sensor is connected to the liquid crystal display by means of A/D converter and a circuit of a microprocessor so that the weight of the article in the spoon head is displayed on the liquid crystal display, and wherein the level meter is disposed in said holder body to keep said weighing spoon horizontal upon weighing.

The holder body is a whole housing composed of the panel, a button, the level meter, a upper case, a lower case and a battery cover. In the interior of the holder body can be disposed a rubber button and a battery. The rubber button is connected to said button that is located over the rubber button and embedded in the panel. Below the rubber button is provided a circuit board. The liquid crystal display is mounted beside the rubber button and between the circuit board and the upper case. Zebra elastomeric connector is mounted between the liquid crystal display and the circuit board so as to make the circuit communicated. The level meter and the liquid crystal display are located on the same side of said holder body (the horizontal cross section as the center), said side being the side where the spoon head is concave. A battery plate is mounted on another side of the circuit board and is connected with the battery therebelow. The battery is located between the battery plate and the battery cover, and a seal ring is provided between the battery cover and the lower case so as to improve water resistance thereof. The level meter mounted on the holder body is located in an opening of the panel, the opening being adjacent to the end where the panel is connected to the upper case. The level meter is used to control the data read from the spoon in the horizontal state most accurate. When the level meter is in the horizontal state, the load bearing direction of the weighing sensor is perpendicular to the horizontal plane. The battery cover is provided at the end of the holder body where the hanging ring is connected to the holder body. The lower case at said end inwardly forms a depressed recess to receive the battery cover, and the battery cover is connected to the holder body via a screw.

Said battery provides power for A/D converter on a circuit board and the circuit of the microprocessor, and drives the liquid crystal display to display the weight of the object being weighed.

Said spoon head is integrally formed with said spoon stem, and the spoon head can be in various shapes to meet different needs of objects being weighed. Said spoon stem is connected to one end of the weighing sensor via a screw, said weighing sensor is located between said upper case and said lower case, said end of said weighing sensor is not in contact with said upper case and said lower case, and the other end thereof is connected with the lower case via a screw located below the upper case.

The advantageous effects of the present utility model are that the weight indicated by the weighing sensor is displayed on the liquid crystal display when needed via use of the spoon body connected to said weighing sensor, a circuit of a group of A/D converter and a microprocessor mounted therein as well as said button. In this manner, a user can more precisely control the amount of article needed in use and stably hold the spoon by virtue of the level meter. The spoon according to the present utility model is reasonable in structure and meanwhile can be conveniently placed by means of the hanging ring. Furthermore, the presence of the seal ring improves the water resistance of the spoon. Said button is used as a switch for controlling the weighing spoon, and functions such as measure unit conversion and maintenance of display can be added. Said weighing spoon can be made as having automatic switch-off function in a manner that the weight does not vary or there is no key pressing operation in a given time, the weighing sensor will automatically switch off to save the power of the battery.

### BRIEF DESCRIPTION OF THE DRAWINGS

FIG. 1 is a top view of the weighing spoon according to one embodiment of the present utility model;

FIG. 2 is a bottom view of the weighing spoon according to one embodiment of the present utility model;

FIG. 3 is a cross-sectional view of the weighing spoon according to an embodiment of the present utility model along the line A-A;

FIG. 4 is a cross-sectional view of the weighing spoon according to an embodiment of the present utility model along the line B-B;

FIG. 5 is a cross-sectional view of the weighing spoon according to an embodiment of the present utility mode along the line C-C.

The reference numeral m denotes a hanging ring; 2 a circuit board; 3 a liquid crystal display; 4 a panel; 5 a rubber button; 6 a button; 7 a level meter; 8, 10, 17, 20 a screw; 9 an upper case; 11 a spoon body; 12 a weighing sensor; 13 a lower case; 14 a seal ring; 15 a battery plate; 16 a battery; 17 a battery cover; 19 zebra elastomeric connector; 21 a spoon head; 22 a spoon stem; 23 a holder body.

### PREFERRED EMBODIMENTS

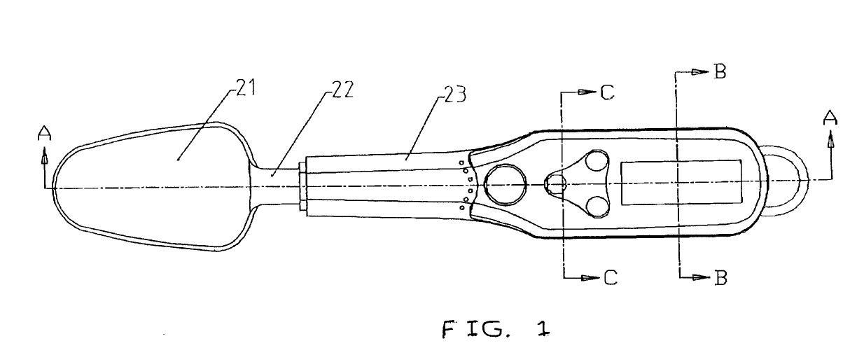

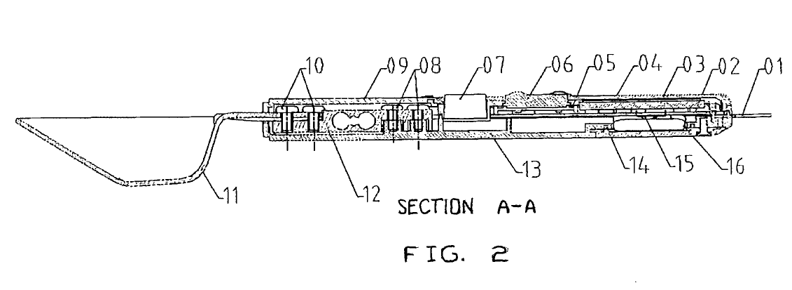

As shown in FIG. 1 and FIG. 2, a weighing spoon according to an embodiment of the present utility model comprises a spoon head 21, a spoon stem 22, a holder body 23, a level meter 7 and a hanging ring 1, wherein the spoon stem 22 is connected to the holder body 23, another end of the holder body 23 is connected to said hanging ring 1, the spoon can be hung via the hanging ring 1 when it is not used, and wherein a weighing sensor 12 and a liquid crystal display 3 are mounted in the holder body 23 in a manner that the weighing sensor 12 is connected to the liquid crystal display 3 by means of A/D converter and a circuit of a microprocessor so that the weight of the article in the spoon head 21 is displayed on the liquid crystal display 3. The weighing sensor 12 and the liquid crystal display 3 are respectively located on the left and right of the whole piece of the button 6 and the level meter7. The spoon head 21 and the spoon stem 22 are integrally formed to constitute a spoon body 1, as shown in FIGS. 1-3. A cavity is formed between the weighing sensor 12 and the upper case 9, and a screw 10 and a screw 8 are disposed in the cavity so that the spoon stem 22 is fixedly connected to one end of the weighing sensor 12 via the screw 10. The weighing sensor 12 is located below the upper case 9 and between the upper case 9 and the lower case 13. Another end of the weighing sensor 12 is fixedly connected to the lower case 13 via the screw 8 located below the upper case 9. The upper case 9 is connected to the panel 4 in the horizontal direction and downwardly connected to the lower case 13.

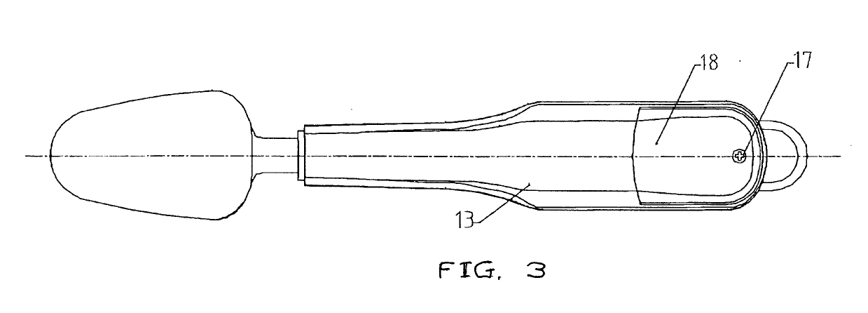

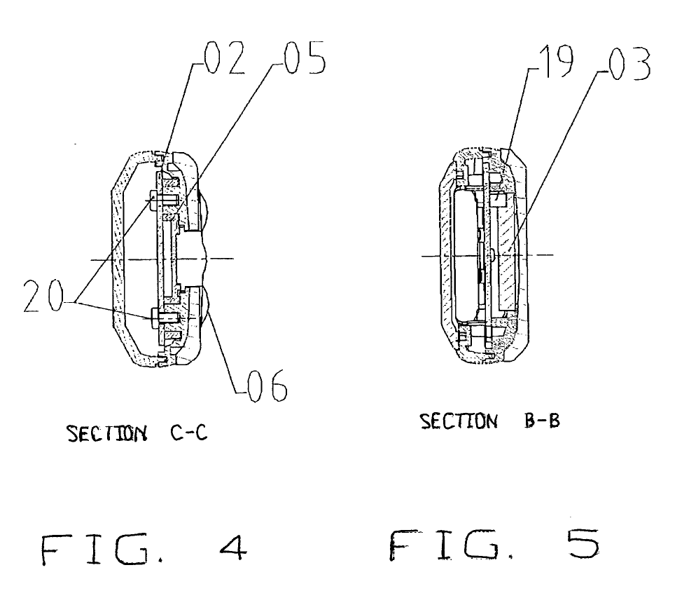

The holder body 23 is a whole housing composed of the panel 4, the button 6, the level meter 7, the upper case 9, the lower case 13 and a battery cover 18. As shown in FIGS. 3-5, in the interior of the holder body 23 are mounted a rubber button 5 and a battery 16. The internal structure of the holder body 23 is described in detail as follows:

The rubber button 5 is connected to the button 6 that is located over the rubber button and embedded in the panel 4. Below the rubber button 5 is mounted an electronic circuit board 2. The liquid crystal display 3 is mounted beside the rubber button 5 and between the electronic circuit board 2 and the upper case 9. Zebra elastomeric connector 19 is mounted between the liquid crystal display 3 and the electronic circuit board 2, and the level meter7 and the liquid crystal display 3 are respectively located on the two sides of the button 6. A battery plate 15 is mounted on another side of the electronic circuit board 2 and is in contact with the battery 16 therebelow. The battery 16 is mounted between the battery plate 15 and the battery cover 18, ad a seal ring 14 is provided between the battery cover 18 and the lower case 13 so as to improve water resistance thereof.

In addition, the level meter 7 mounted on the holder body 23 is located in an opening of the panel 4, the opening being adjacent to the end where the panel is connected to the upper case 9.

The battery cover 18 is provided at the end where a hanging ring I is connected to the holder body 23. The lower case 13 at said end inwardly forms a depressed recess to receive the battery cover 18, and the battery cover 18 is fixedly connected to the lower case 13 of the holder body 23 via a screw 17.

1. A weighing spoon, characterized in that it comprises a spoon body, a holder body, a level meter and a hanging ring, wherein said spoon body consists of a spoon head and a spoon stem, the spoon stem is connected to a weighing sensor disposed in said holder body, the hanging ring is attached to said holder body, the level meter is disposed in said holder body, said holder body is provided with a liquid crystal display, the weighing sensor is related to the liquid crystal display by means of A/D converter on a circuit board and a circuit of a microprocessor.

2. The weighing spoon as claimed in claim 1, characterized in that the holder body is a whole housing composed of the panel, a button, an upper case, a lower case and a battery cover, in that in the interior of the holder body is disposed a rubber button and a battery, the rubber button is connected to said button that is located over the rubber button and embedded in the panel, in that below the rubber button is provided a circuit board, in that the liquid crystal display is mounted beside the rubber button and between the circuit board and the panel, in that a battery plate is disposed on another side of the circuit board and is connected with the battery therebelow, and in that the battery is located between the battery plate and the battery cover.

3. The weighing spoon as claimed in claim 1, characterized in that said spoon stem is connected to one end of the weighing sensor via a screw, said weighing sensor is located between said upper case and said lower case, said end of said weighing sensor is not in contact with said upper case and said lower case, and the other end thereof is connected with the lower case via a screw located below the upper case.

4. The weighing spoon as claimed in claim 2, characterized in that the level meter and the liquid crystal display are located on the same side of said holder body, said side being the side where the spoon head is concave.

5. The weighing spoon as claimed in claim 2, characterized in that the designed load bearing direction of said weighing sensor is parallel to the normal direction of the plane of the level meter.

6. The weighing spoon as claimed in claim 2, characterized in that a seal ring is provided between the battery cover and the lower case.

7. The weighing spoon as claimed in claim 2, characterized in that the level meter mounted on the holder body is located in an opening of the panel, the opening being adjacent to the end where the panel is connected to the upper case.

8. The weighing spoon as claimed in claim 2, characterized in that the battery cover is provided at the end of the holder body where the hanging ring is connected to the holder body, the lower case at said end inwardly forms a depressed recess to receive the battery cover, and in that the battery cover is connected to the holder body via a screw.
